(19) United States
(12) Patent Application Publication
(10) Pub. No.: US 2013/0052422 A1
(43) Pub. Date: Feb. 28, 2013

(54) PATTERNING SHEET AND MANUFACTURING METHOD THEREFOR

(71) Applicants: Satoshi Ohya, Sakura-shi (JP); Toshiro Ariga, Sakura-shi (JP)

(72) Inventors: Satoshi Ohya, Sakura-shi (JP); Toshiro Ariga, Sakura-shi (JP)

(73) Assignee: DIC CORPORATION., Tokyo (JP)

(21) Appl. No.: 13/577,806

(22) PCT Filed: Feb. 28, 2011
(86) PCT No.: PCT/JP2011/054478

§ 371 Date: Nov. 7, 2012

(30) Foreign Application Priority Data
Mar. 5, 2010 (JP) 2010-049062

(51) Int. Cl. B32B 3/28; C08L 67/03

(52) U.S. Cl. 428/156; 522/179

(57) ABSTRACT

Provided is a patterning sheet that is inserted into an injection mold during injection molding and detached after the injection molding to produce recesses and protrusions on an injection molded product, the patterning sheet having a thickness difference in some part and being made by irradiating an infrared ray on a heat-shrinkable resin sheet having a portion A and a portion B in a surface, the portion A and the portion B having infrared absorbing properties different from each other. Also provided is a method for making the patterning sheet, the method including irradiating a heat-shrinkable resin sheet having a portion A and a portion B, which have infrared-absorbing properties different from each other, on a surface with an infrared ray while restraining the resin sheet so that surface temperatures of the portion A and the portion B are different from each other and at least the surface temperature of the portion A is equal to or more than an orientation release stress inflection point temperature T of the resin sheet to generate a thickness difference between the portion A and the portion B.

### TECHNICAL FIELD

The present invention relates to a patterning sheet that is inserted into an injection mold during injection molding and detached after the injection molding to produce recesses and protrusions on an injection molded product, and to a method for making the patterning sheet.

### BACKGROUND ART

As an injection molded product having recesses and protrusions on its surface, a method for forming recesses and protrusions on a surface of an injection molded product by forming fine bosses on a cavity surface of an injection mold is known. However, this method has faced problems such as that the recesses and protrusions must be formed on every mold, resulting in an increase in cost, and that it is difficult to accurately reproduce minute recesses and protrusions because injection molding resins do not readily fill the gaps between fine bosses.

Also known is a method of producing recesses and protrusions by placing a patterning sheet, on which recesses and protrusions have been preliminarily formed through a physical technique such as contact-pressing the sheet surface with a patterning sheet or a heated engraved roll formed by embossing or Shreiner-finishing, in the interior of an injection mold and detaching the patterning sheet after the injection molding. According to this method, the cost is high since an embossing machine or a special printing step is needed in the process for making the sheet and the plate must be changed according to the pattern of the recesses and protrusions. Since the recesses and protrusions are already present in the sheet in a wound state, problems related to handling are likely to occur such as winding slippage failures and gauge band failures resulting from the overlap of the protruding portions. Moreover, embossed portions exposed to a high resin temperature during injection molding are plastically deformed due to orientation release, leading to a problem of failure to form desired recesses and protrusions.

Another patterning method known in the art includes inserting a patterning film into an injection mold, injecting a resin into the injection mold to bring the patterning film into close contact with the resin so as to transfer minute recesses and protrusions of the patterning film onto a surface of the resin, and detaching the patterning film so as to produce minute recesses and protrusions on a surface of a three-dimensional injection molded product, in which the patterning film is a cured product of a photosetting resin composition that contains an acrylate oligomer selected from urethane acrylate, polyester acrylate, epoxy acrylate, and polyether acrylate and a releasing agent as essential components and is constituted by a base member and a recess/protrusion-forming layer formed by using a metal stamper plate as a mold, and the surface of the recess/protrusion-forming layer has minute recesses and protrusions (for example, refer PTL 1). However, this patterning film is constituted by a plurality of layers including the base member and the recess/protrusion-forming layer and has a problem in that the recess/protrusion-forming layer becomes separated from the base member during injection molding or the detaching and cannot be completely detached. Moreover, since a stamper plate is used, the plate must be changed according to the pattern of the recesses and protrusions.

### CITATION LIST

### Patent Literature

PTL 1: Japanese Unexamined Patent Application No. 2004-284178

### SUMMARY OF INVENTION

### Technical Problem

An object of the present invention is to provide a patterning sheet that can be used in a method for producing an injection molded product having recesses and protrusions on a surface. The patterning sheet does not require embossing, has high handling ease, can accurately reproduce complex recesses and protrusions, and can form, at a high reproducibility, an injection molded product with good design formed by deep recesses and high protrusions that are sufficiently identifiable visually or by touch.

### Solution to Problem

The inventors of the present invention have achieved the object by using a patterning sheet that has a thickness difference in some part, the patterning sheet being made by irradiating an infrared ray on a heat-shrinkable resin sheet having a portion A and a portion B in a surface, the portion A and the portion B having infrared-absorbing properties different from each other.

A patterning sheet is obtained by irradiating a heat-shrinkable resin sheet having a portion A and a portion B, which have infrared-absorbing properties different from each other, in a surface with an infrared ray while restraining the resin sheet so that surface temperatures of the portion A and the portion B are different from each other and at least the surface temperature of the portion A is equal to or more than an orientation release stress inflection point temperature T of the resin sheet to generate a thickness difference between the portion A and the portion B.

When heated, a heat-shrinkable resin sheet shrinks to return to the state before stretching. The force exhibited during this process is the orientation release stress and the stress changes with the heating temperature.

The inventors have found that when the heat-shrinkable resin sheet is heated while being restrained so that a plurality of portions in the same surface of the resin sheet have different surface temperatures and that at least one of the plurality of portions has a surface temperature equal to or more than the orientation release stress inflection point temperature T of the resin sheet, thickness differences are generated in these portions due to differences in sheet behaviors of the portions. The present invention succeeded in intentionally generating thickness differences, i.e., recesses and protrusions, by using the temperature differences in the sheet.

Infrared irradiation that renders a plurality of portions in the same surface of the resin sheets to have different surface temperatures (a portion with a relatively high surface temperature is referred to as a portion A and a portion with a relatively low surface temperature is referred to as a portion B) is achieved through methods of using an infrared-absorbing ink or an infrared-reflecting ink ((1) to (3) below).

An infrared-absorbing ink or an infrared-reflecting ink is an ink that reacts to infrared rays.

An infrared-absorbing ink is an ink that contains an infrared-absorbing agent or the like and generates heat by absorbing the infrared ray applied. In other words, when a resin sheet on which an infrared-absorbing ink is printed is irradiated with an infrared ray, heat in a quantity higher than that applied by the infrared irradiation is applied to only the portion on which the infrared-absorbing ink is printed.

In contrast, an infrared-reflecting ink is an ink that contains an infrared-reflecting substance and reflects the infrared ray applied. When a resin sheet on which an infrared-reflecting ink is printed is irradiated with an infrared ray from the resin-sheet-side (side opposite to the printed surface of the resin sheet), the infrared ray that has passed through the resin sheet is reflected by the infrared-reflecting ink. As a result, heat in a quantity higher than that applied by the infrared irradiation is applied to only the portion in which the infrared-transmitting portion and the infrared-reflecting portion overlap each other (This is presumably achieved since heat can be more efficiently supplied to the portion A of the sheet than to the portion B on which no design is formed).

In other words, since heat in a quantity higher than that applied by the infrared irradiation is applied to the portion on which the infrared-absorbing ink or infrared-reflecting ink is printed, the surface temperature of such a portion can be increased and a temperature difference can be generated in the resin sheet between the portion on which the infrared-absorbing ink is printed and the portion on which the infrared-absorbing ink is not printed.

To be more specific, (1) a design is formed on a heat-shrinkable resin sheet with an infrared-absorbing ink or an infrared-reflecting ink and infrared irradiation is conducted so that a portion A on which a design is formed with the infrared-absorbing ink or infrared-reflecting ink has a different surface temperature from a portion B on which no design is formed. Since heat in a quantity higher than that applied by infrared irradiation is applied only to the portion A, the surface temperature of the portion A becomes higher than that of the portion B on which no design is printed.

Alternatively, (2) a design is formed on a heat-shrinkable resin sheet with an infrared-absorbing ink or an infrared-reflecting ink so that the resin sheet has a portion A having a high ink concentration and a portion B having a low ink concentration and infrared irradiation is conducted so that the portion A having a high ink concentration and the portion B having a low ink concentration have different surface temperatures.

In such a case, heat in a quantity higher than that applied by infrared irradiation is applied to both the portion A and the portion B. However, more heat is applied to the portion A since the ink concentration is higher than in the portion B. Thus, the surface temperature of the portion A becomes higher than that of the portion B.

Alternatively, (3) a design is formed on a heat-shrinkable resin sheet with a plurality of types of infrared-absorbing inks or infrared-reflecting inks having different infrared absorbance or reflectance and the surface temperature of a portion A on which a design is formed with an ink having a high infrared absorbance or reflectance is controlled to be different from the surface temperature of a portion B on which a design is formed with an ink having a low infrared absorbance or reflectance.

In such a case, heat in a quantity higher than that applied by infrared irradiation is applied to both the portion A and the portion B. However, since an ink having a higher infrared absorbance or reflectance is formed on the portion A than on the portion B, more heat is applied to the portion A. Accordingly, the surface temperature of the portion A is high relative to the portion B.

In other words, the present invention provides a patterning sheet that can form recesses and protrusions on a surface of an injection molded product by conducting injection molding while inserting the patterning sheet in an injection mold and then detaching the patterning sheet, in which the patterning sheet has a thickness difference in some part and is formed by irradiating an infrared ray on a heat-shrinkable resin sheet having a portion A and a portion B that are formed in a surface and have different infrared-absorbing properties.

The present invention also provides a method for making the patterning sheet according, the method including irradiating a heat-shrinkable resin sheet having a portion A and a portion B, which have infrared-absorbing properties different from each other, in a surface with an infrared ray while restraining the resin sheet so that surface temperatures of the portion A and the portion B are different from each other and at least the surface temperature of the portion A is equal to or more than an orientation release stress inflection point temperature T of the resin sheet to generate a thickness difference between the portion A and the portion B.

### Advantageous Effects of Invention

When a patterning sheet of the present invention is used, handling ease is improved, complex recesses and protrusions can be accurately reproduced, and an injection molded product with good design formed by deep recesses and high protrusions that are sufficiently identifiable visually or by touch can be obtained with high reproducibility.

The patterning sheet of the present invention has recesses and protrusions on both surfaces if not subjected to preforming and has recesses and protrusions on one surface if subjected to preforming. In either case, the patterning sheet can be used in injection molding.

The patterning sheet of the present invention has a recess/protrusion shape in which the inner stress of the sheet itself is relaxed. Thus, recesses and protrusions remain as are under heat and pressure applied during preforming or injection molding and complex recesses and protrusions can be accurately reproduced on injection molded products. Accordingly, recesses and protrusions can be formed on a surface of an injection molded product by conducting injection molding while inserting the patterning sheet in an injection mold and then detaching the patterning sheet.

In the present invention, when techniques (1) to (3) described above are employed so that a plurality of portions in the same surface of the resin sheet have different surface temperatures, recesses and protrusions are formed in portions on which a design is drawn with an infrared-absorbing ink or an infrared-reflecting ink. The design can be printed with an ink by a common printing method such as gravure printing, screen printing, ink jet printing or the like. Since physical processes for forming recesses and protrusions are not needed, failures such as winding slippage and gauge band are suppressed and excess facilities such as for embossing are not needed in the sheet-making step. Thus, the cost can be reduced.

### DESCRIPTION OF EMBODIMENTS

### Definition of Recesses and Protrusions

As has been described above, in the present invention, the recesses and protrusions are formed by rendering a portion A and a portion B adjacent to each other in the same surface of a heat-shrinkable resin sheet to have different surface temperatures while restraining the resin sheet. In the present invention, a portion having a relatively high surface temperature is defined as a portion A and a portion having a relatively low surface temperature is defined as a portion B. The portion A forms a relatively recessed portion and the portion B forms a relatively protruding portion.

It is presumed that when a heat-shrinkable resin sheet is irradiated with an infrared ray, the central part of the portion A undergoes thinning due to a spontaneous shrinking behavior as the resin is plasticized and orientation of the resin sheet is released.

When such a change in thickness caused by the spontaneous shrinking behavior occurs while not restraining the resin sheet, shrinkage occurs in all parts without any starting point and the thickness of the sheet tends to increase in all parts. However, when the resin sheet is restrained with clamps or the like, shrinkage tends to occur from clamped portions having low temperatures as starting points, presumably resulting in thinning of the portion A. Accordingly, in most cases, the portion A becomes thinner than the resin sheet before infrared irradiation, i.e., before shrinking.

In contrast, the portion B is a portion adjacent to the portion A and having a different surface temperature from the portion A, i.e., a temperature lower than that of the portion A. The thickness of the portion B increases relative to the portion A presumably because the resin component in the portion A migrates to the portion B due to the thinning in the central part of the portion A or because spontaneous shrinking occurs in the portion B. In most cases, the portion B is thicker than the resin sheet before infrared irradiation, i.e., before shrinking. The border between the portion A and the portion B is observed to be thicker. As a result, a shaper three-dimensional appearance can be obtained.

An example of forming the recesses and protrusions is shown in FIGS. 1 and 2. FIG. 1 is diagram showing a specific embodiment in which a heat-shrinkable resin sheet having a pattern printed with three types of inks, i.e., a high-concentration infrared-absorbing ink, a low-concentration infrared-absorbing ink, and a (non-infrared-absorbing) color ink, is irradiated with an infrared ray using an infrared heater. FIG. 2 is a diagram showing the state of the resin sheet after the infrared ray was applied while restraining the resin sheet in FIG. 1.

When the resin sheet is irradiated with an infrared ray as shown in FIG. 1, printed portions 4, i.e., portions A, on which a high-concentration infrared-absorbing ink is printed, become thin or form recesses, and a low-concentration infrared-absorbing ink 5 becomes thicker than the printed portions 4 but thinner than a portion 6 on which the color ink is printed and forms a protrusion relative to the printed portions 4, as shown in FIG. 2. The portion 6 on which the color ink is printed is the thickest and thus forms the highest protrusion.

In the case where a resin sheet has a non-printed portion without using the portion 6 on which the color ink is printed, the portions on which the high-concentration infrared-absorbing ink is printed form recesses, the portions on which the low-concentration infrared-absorbing ink is printed form low protrusions, and the portions on which no ink is printed form the highest protrusions (not shown in the drawings).

Since the thickness increases in some parts and decreases in other parts, recesses and protrusions are formed.

Formation of the recesses and protrusions evenly occurs on both sides of the resin sheets as shown in FIG. 2. Thus, the recesses and protrusion are also formed on the surface that comes into contact with the adherend of the resin sheet.

The height difference among the recesses and protrusion can be measured with a surface roughness meter or a thickness meter. The recesses and protrusion are recognizable as long as the difference (hereinafter referred to as the thickness difference) between the highest portion and the lowest portion of the surface is about 10 μm. In order to develop clearly recognizable recesses and protrusions, the thickness difference is preferably about 15 μm and more preferably 20 μm or more. Since the thickness difference decreases in proportion to the factor of expansion, the thickness difference of the pattern tends to decrease as the molding becomes deeper. The widths of the recesses and protrusions tend to increase with the increase in the factor of expansion.

In the present invention, there is no limit as to the design expressed by the recesses and protrusions. The thickness, size, shape, etc., of the lines that express the design such as patterns and characters are also not particularly limited. In other words, in the present invention, since the recesses and protrusions can be formed by printing, hand-writing, etc., as long as the techniques (1) to (3) described above are used, any recesses and protrusions can be formed as long as they express a design or a character that can be formed into a plate or that can be printed.

Examples of the design include any drawings formed by dots or lines (e.g., pictures, outlines of characters, wood grains, stripes, and hairlines), dots, and geometric patterns. In the case where it is desirable to give a character or a mark an emboss-like appearance, the area of that pattern is preferably small. In the present invention, no limitation is imposed and any designs, characters, and patterns can be expressed.

FIGS. 3 to 6 show examples of the designs formed by the recesses and protrusions according to the present invention. The dark portions are portions on which an infrared-absorbing ink or an infrared-reflecting ink was printed. FIG. 3 shows a stripe pattern, FIG. 4 shows a dot pattern, FIG. 5 shows a geometric pattern, and FIG. 6 shows a wood grain pattern.

### (Surface Temperature)

In the present invention, the indicator of the temperature is defined as the “surface temperatures of the portion A and the portion B”. However, as described above, the thermal behaviors of the portion A and the portion B of the resin sheet presumably occur not only on the surfaces of the portions A and B but also evenly in the interiors. However, since there is no means for measuring the internal temperature, the surface temperatures were used as the indicator. In the present invention, the surface temperature was measured with “Thermo Tracer 9100” produced by NEC/Avio.

### (Heat-Shrinkable Resin Sheet)

A heat-shrinkable resin sheet used in the present invention (hereinafter referred to as a “resin sheet S”) is a resin that can be formed into a film by exhibiting expandability under heating and that has an inflection point for orientation release stress. The resin sheet is preferably a thermoplastic resin sheet since expansion by vacuum molding is easy.

The orientation release stress inflection point temperature in the present invention is a film temperature at the time heat is applied to the film from the outside. When the film itself reaches this temperature, the stretched molecules start to shrink and the entire film starts to shrink. In the present invention, the orientation release stress inflection point temperature T is defined by the following process.

That is, the orientation release stress used in the present invention is measured in accordance with ASTM D-1504. The orientation release stress is the force that works under heating when a stretched sheet is returning to the state before stretching. The orientation release stress is determined as the value of the maximum stress at each measurement temperature divided by the cross-sectional area of the sheet and is an indicator of the degree of orientation of the molecules of the stretched sheet.

In the present invention, the aforementioned heat-shrinking stress measurement method is used and the temperature T at the inflection point on a positive curvature of a positive slope graph showing the relationship between the orientation release stress and the heating temperature is determined. When there are two or more inflection points on positive curvatures, the temperature at the inflection point in the highest temperature zone was assumed to be the orientation release stress inflection point temperature T.

To be more specific, DN-type Stress Tester produced by Nichiri Kogyo Kabushiki Kaisha was used, the scale of a voltage adjustor was set to 6, and the heater temperature was elevated in increments of 5° C. The orientation release stress at each measurement temperature was measured. After the shrinkage stress was exhibited, the inflection point temperature T of the graph showing the relationship between the orientation release stress and the heating temperature was determined. An example is shown in FIG. 7. FIG. 7 is a graph taken from a biaxially oriented PET sheet “Soft Shine X1130 (thickness: 125 μm) (sheet S1 in Examples) produced by TOYOBO Co., Ltd. The temperature T of 188° C. at the inflection point on a positive curvature in the highest temperature zone in the graph was assumed to be the orientation release stress inflection point temperature T of the sheet S1.

As described above, a resin sheet having an orientation release stress inflection point is usually subjected to stretching. Stretching is usually conducted by melt-extruding a resin into a sheet by an extrusion film-forming technique or the like and subjecting the sheet to uniaxial stretching, simultaneous biaxial stretching, or sequential biaxial stretching. In the case of sequential biaxial stretching, the machine direction stretching is usually conducted first and the transversal stretching the next. In particular, a method that combines machine direction stretching that utilizes the difference in speed between the rolls and transverse direction stretching using a tenter is frequently employed.

An advantage of the tenter method is that large-width products can be obtained and the productivity is high. The stretching conditions and the like are not particularly limited since they differ depending on the resin plasticity, the physical properties desired, moldability, etc. However, usually, the stretching factor is 1.2 to 18 and preferably 2.0 to 15 in terms of area factor. The stretching factor in the machine direction in the sequential stretching is preferably 1.2 to 5 and more preferably 1.5 to 4.0. The stretching factor in the cross direction crossing the machine direction is 1.1 to 5 and preferably 1.5 to 4.5. The stretching factor in each direction in simultaneous biaxial stretching is 1.1 to 3.5 and preferably 1.2 to 4.2.

In particular, an oriented sheet such as a uniaxially oriented sheet or a biaxially oriented sheet can be used but a biaxially oriented sheet is preferred since the effects of the present invention are maximized. Moreover, when a simultaneously biaxially oriented sheet is used, a recess/protrusion design free of deformation can be obtained since the in-plane shrinkage ratio is uniform. In some cases, uniaxially stretched sheet of a two-step sequentially biaxially oriented sheet is used by preliminarily taking the deformation into consideration.

Any stretchable resin can be used as the resin. Examples thereof include polyester resins such as polyethylene terephthalate and polybutylene terephthalate, polyolefin resins such as polyethylene and polypropylene, polyvinyl chloride, acrylic resins, polystyrene resins, nylons, and vinylon. Among these, polyester resins are preferred since the thickness after stretching is highly even.

The thickness of the resin sheet S may be any thickness usually employed for the thermoforming sheets. In general, sheets having a thickness of about 0.1 to 0.5 mm are preferable for use.

Application of an infrared ray that renders surface temperatures of two or more portions in the same surface of the resin sheet can be achieved by employing an infrared-absorbing ink or an infrared-reflecting ink described in (1) to (3) above.

### (Infrared-Absorbing Ink or Infrared-Reflecting Ink)

The infrared-absorbing ink or the infrared-reflecting ink used in the techniques described in (1) to (3) above will now be described.

An infrared-absorbing ink is an ink that contains an infrared absorber. An infrared-reflecting ink is an ink that contains an infrared-reflecting substance. They are both used as security inks and the like.

As described above, the infrared-absorbing ink absorbs an infrared ray applied and generates heat. In other words, when an infrared ray shines a resin sheet on which an infrared-absorbing ink is printed, a heat in a quantity larger than the infrared radiation dose is applied only to the portions on which the infrared-absorbing ink is printed. In contrast, an infrared-reflecting ink is an ink that contains an infrared-reflecting substance and reflects the infrared ray applied. When an infrared ray shines the resin sheet on which the infrared-reflecting ink is printed from the resin sheet side (the side opposite the printed surface of the resin sheet), the infrared ray that has passed through the resin sheet is reflected at the infrared-reflecting ink and thus heat in a quantity larger than the infrared radiation dose is applied to printed portions where the portion through which the infrared ray passes through and the portion at which the infrared ray is reflected overlap each other. In other words, heat in a quantity larger than that imparted by the infrared irradiation is applied only to portions on which the infrared-absorbing ink or the infrared-reflecting ink is printed, and thus the surface temperature of such portions can be increased. As a result, a temperature difference is generated in the resin sheet between a portion on which the infrared-absorbing ink is printed and a portion on which the infrared-absorbing ink is not printed.

In the present invention, the temperature of the resin sheet S itself is increased by infrared irradiation so that the temperature is within an elastic region suitable for thermoforming. When the resin sheet S has a portion on which an infrared-absorbing ink or an infrared-reflecting ink is printed, more heat is applied to such a portion and thus recesses and protrusions are formed. Here, it is sufficient if the portion A (portion having a relatively high surface temperature) has a surface temperature equal to or greater than the orientation release stress inflection point temperature T of the resin sheet. The difference in temperature between the portion A and the portion B is preferably 7° C. or more, more preferably 10° C. or more since deeper recesses and higher protrusions can be formed, and most preferably 15° C. or more.

The infrared ray may be applied so that only the portion A has a surface temperature equal to or more than the orientation release stress inflection point temperature T. Alternatively, the infrared ray may be applied so that both the portion A and the portion B have surface temperatures equal to or more than the orientation release stress inflection point temperature T. Deeper recesses and higher protrusions can be formed in the latter case.

Preferable examples of the infrared-absorbing ink include inks that contain substances that are generally commercially available as infrared-absorbing agents or various types of known infrared-absorbing pigments and dyes that generate heat by absorbing the wavelengths in the red to near infrared region and the infrared laser beam region. Specific examples of the infrared-absorbing agents include pigments and dyes such as insoluble azo pigments, azo lake pigments, condensed azo pigments, chelating azo pigments, phthalocyanine-based pigments, anthraquinone-based pigments, perylene and perinone-based pigments, thioindigo-based pigments, quinacridone-based pigments, dioxazine-based pigments, isoindolinone-based pigments, quinophthalone-based pigments, dyed lake pigments, azine pigments, nitroso pigments, nitro pigments, natural pigments, fluorescent pigments, inorganic pigments, carbon blacks, azo dyes, metal complex salt azo dyes, pyrazolone azo dyes, anthraquinone dyes, phthalocyanine dyes, carbonium dyes, quinoneimine dyes, methine dyes, cyanine dyes, carbon black, titanium black, titanium oxide, Cu—Cr-based complex oxides, phthalocyanine, naphthalocyanine, and cyanine; polymethine-based pigments and dyes; and other red-absorbing agents, near-infrared-absorbing agents, and infrared-absorbing agents such as squarylium dyes.

Examples of the infrared-reflecting substance contained in the infrared-reflecting ink include metals such as aluminum, gold, silver, copper, brass, titanium, chromium, nickel, nickel chromium, and stainless steel, Fe—Cr-based complex oxides, antimony trioxide, and antimony dichromate.

The particle diameter of the infrared-absorbing agent and the infrared-reflecting substance is not particularly limited and any particle diameter within the range normally employed in the inks can be employed.

The quantity of heat applied to the portion A increases with the ink concentration. Thus, the content is preferably adequately changed according to the desired degree of the recesses and protrusions. When the concentration is excessively low, the quantity of heat generated by infrared irradiation and the quantity of reflected infrared radiation are too low to form recesses. When the concentration is excessively high, the quantity of heat generated by infrared irradiation and the quantity of reflected infrared radiation are too high, resulting in rupture and holes. Thus, an adequate adjustment need to be made so that the elastic modulus during molding is not 0.5 MPa or less as described below.

The ink varnish is also not particularly limited and known resins for varnish can be used. Examples of the resins for varnish include known inks based on acrylic resins, polyurethane resins, polyester resins, vinyl resins (vinyl chloride, vinyl acetate, and vinyl chloride-vinyl acetate copolymer resins), chlorinated olefin resins, ethylene-acrylic resins, petroleum-based resins, and cellulose derivative resins.

In the techniques (1) to (3) described above, a design is drawn on the resin sheet S with an infrared-absorbing ink or an infrared-reflecting ink by hand-writing, coating, printing, etc. From the industrial viewpoint, printing is preferred. The method is not particularly limited and examples of the method include gravure printing, offset printing, screen printing, ink jet printing, brushing, roll coating, comma coating, rod gravure coating, and microgravure coating. Among these, gravure printing is preferred.

Usually, as shown in FIG. 1, an infrared ray applied so that it passes through the resin sheet and reaches the infrared-absorbing ink or the infrared-reflecting ink layer. In particular, when an infrared-reflecting ink is used, the infrared-reflecting ink reflects the infrared ray before the infrared ray passes through the resin sheet and the printed portion of the resin sheet may not be plasticized due to failure to transmit the infrared ray unless this irradiation method is employed.

According to the technique (1) above, heat in a quantity larger than the infrared radiation dose is applied to the portion A on which a design is formed with an infrared-absorbing ink or an infrared-reflecting ink. Thus, the surface temperature of the portion A becomes relatively high and the portion A forms a recess. In contrast, only the heat of infrared irradiation is applied to the portion B on which no design is formed. Thus, the surface temperature of the portion B becomes lower than that of the portion A and the portion B forms a protrusion.

According to the technique (2), heat in a quantity larger than the infrared radiation dose is applied to both the portion A and the portion B. However, since the ink concentration in the portion A is higher than that in the portion B, more heat is applied to the portion A than to the portion B. Accordingly, the surface temperature of the portion A is higher than that of the portion B and the portion A and the portion B form a recess and a protrusion, respectively.

In the technique (2), it is possible to adjust the ink concentration by forming the portion A and the portion B by using inks of different concentrations or by using one type of ink and increasing the amount of ink applied to the portion A to be larger than that applied to the portion B, for example.

The number of the portion A need not be 1. For example, when three different types of inks with different ink concentrations are used, the portion on which the ink having the lowest concentration is used forms a portion B and a recess. The portion on which the ink having the highest concentration is used forms the deepest recess or a portion A′. Naturally, it is possible to achieve the same by adjusting the amount of ink applied.

In the technique (3), heat in a quantity larger than the infrared radiation dose is applied to both the portion A and the portion B. However, since an ink having a higher infrared absorbance or reflectance is applied to the portion A than to the portion B, a higher quantity of heat is applied to the portion A than to the portion B. As a result, the surface temperature in the portion A becomes higher than that in the portion B, and the portion A and the portion B respectively form a recess and a protrusion.

Although the absorbance of the infrared-absorbing ink or the reflectance of the infrared-reflecting ink cannot be absolutely defined, the rough estimate is as follows. That is, when an infrared-reflecting ink containing aluminum and an infrared-absorbing ink containing carbon black are used in combination, the ink containing aluminum forms a recess and the ink containing carbon black forms a protrusion. When an infrared-absorbing ink containing carbon black and an infrared-absorbing ink containing titanium oxide are used in combination, the ink containing carbon black forms a recess and the ink containing titanium oxide forms a protrusion.

Accordingly, when an ink containing aluminum is printed onto a portion A and an ink containing carbon black is printed onto a portion B, the portion A forms a recess and the portion B forms a protrusion. When an ink containing carbon black is printed onto a portion A and an ink containing titanium oxide is printed onto a portion B, the portion A forms a recess and the portion B forms a protrusion. As such, the choice of heat-generating substances may be appropriately made by considering the desired designs formed by protrusions and recesses and the visibility of the design.

The techniques (1) to (3) may be combined. For example, printing may be conducted on a resin sheet S with an infrared-absorbing ink so that there are portions subjected to single-plate printing and portions subjected to multi-plate printing. In the cases where non-printed portions are formed, the portions subjected to multi-plate printing form the deepest recesses, the portions subjected to single-plate printing form protrusions relative to the portions subjected to multi-plate printing and recesses relative to the non-printed portions, and the non-printed portions form protrusions.

When printing is conducted by using an infrared-absorbing ink having a low concentration and an infrared-absorbing ink having a high concentration and a non-printed portion is formed, the portions on which the ink with a high concentration is applied form the deepest recesses, the portions on which the ink with a low concentration is applied form protrusions relative to the portions on which the ink with a high concentration is printed and recesses relative to the non-printed portions, and the non-printed portions form recesses.

### (Design Layer)

A design layer that can be transferred to an injection molded product can be formed on the resin sheet S. For example, when a patterning sheet that includes the resin sheet S, the releasing layer, and the infrared-absorbing or -reflecting ink for generating recesses and protrusions which are stacked in that order is inserted into an injection mold to conduct injection molding and then detached, detachment occurs between the releasing layer and the infrared-absorbing or -reflecting ink. Thus, the infrared-absorbing or -reflecting ink is transferred to the injection molded product, i.e., a decorated injection molded product having a design along the protrusions and recesses can be obtained. A widely available coloring material or the like may be added to the infrared-absorbing or -reflecting ink depending on the desired design. The advantage of the widely available coloring material can be fully exhibited when a highly transparent infrared-absorbing agent or infrared-reflecting substance is used. A design layer may be separately formed with an ink containing a widely available coloring material by changing the plate. In this case, the coloring material used is not particularly limited. Since a coloring material that absorbs heat can generate recesses and protrusions in the printed portions, the blend ratio of such a coloring material is preferably changed according to the purpose.

When a common color ink (which does not absorb or reflect infrared rays) is used in addition to the infrared-absorbing ink or the infrared-reflecting ink, the design other than the design along the recesses and protrusions can be transferred.

### (Surface Protection Layer)

One or more transparent, semi-transparent, or a colored clear surface protective layers may be formed to impart properties such as friction resistance, scratch resistance, weatherability, antifouling property, water resistance, chemical resistance, heat resistance, etc., in the case where the design layer is to be transferred. The surface protection layer is preferably provided between the releasing layer described below and the design print layer to be transferred. In this manner, the printed layer comes under the surface protection layer and the design on the resulting injection molded product can be protected. In particular, the layers are preferably stacked in the order of resin sheet S/releasing layer/transparent cured resin layer/design printed layer to be transferred/adhesive layer. In order to also transfer the infrared-absorbing or -reflecting ink layer onto the surface of an injection molded product, the layers are preferably stacked in the order of resin sheet S/releasing layer/transparent cured resin layer/design printed layer and infrared-absorbing or -reflecting ink layer to be transferred/adhesive layer.

The surface protection layer may be a resin layer that exhibits plasticity at a temperature higher than the resin sheet S and preferably has flexibility that can follow to some extent the difference in thickness between the portion A and the portion B. From such a viewpoint, a methacrylic resin layer having a high glass transition temperature and a surface protection layer that is partly crosslinked so as not to obstruct spreadability are preferable. The form of crosslinking is not particularly limited. Any known reaction such as a thermosetting reaction of an isocyanate and a hydroxyl group, a thermosetting reaction of an epoxy group and a hydroxyl group, a UV-curing or thermosetting reaction that uses a radical polymerization reaction of (meth)acryloyl groups, or a hydrolytic condensation reaction of a silanol group or a hydrolyzable silyl group may be used. A thermosetting reaction of an isocyanate and a hydroxyl group is preferred since the crosslinking reaction can be accelerated by using the heat applied during thermoforming. The surface protection layer is preferably transparent, semitransparent, or clear colored in order to render the recess/protrusion pattern (sense of depth) visually recognizable.

### (Releasing Layer)

A releasing layer is preferably formed on the resin sheet S to facilitate transfer of the surface protection layer and the ink containing heat-generating substance onto an injection molded product. The releasing layer is detached from the mold together with the resin sheet S when the resin sheet S is detached. Examples of the material for the releasing layer include epoxy resin-based releasing agents, epoxy-melamine resin-based releasing agents, amino-alkyd resin-based releasing agents, melamine resin-based releasing agents, silicone resin-based releasing agents, fluororesin-based releasing agents, cellulose derivative-based releasing agents, urea resin-based releasing agents, polyolefin resin-based releasing agents, paraffin-based releasing agents, and composite-type releasing agents thereof. Fine powder such as calcium carbonate, silica, zinc oxide, magnesium carbonate, polyethylene wax, glass beads, etc., may be added to the releasing layer so as to develop a matte appearance.

Examples of the method for forming the releasing layer include various printing techniques and coating techniques.

### (Adhesive Layer)

An adhesive layer or sticking layer commonly used in thermal transfer sheets may be provided to enhance the adhesiveness between the ink layer and the injection molded product.

An adhesive layer may be optionally used to satisfactorily bond the ink to the injection molding resin and thus the adhesive needs to be selected according to the type of the injection molding resin. Examples of typical adhesives include acrylic resins, urethane resins, urethane-modified polyester resins, polyester resins, epoxy resins, ethylene-vinyl acetate copolymer resins (EVA), vinyl chloride resins, vinyl chloride-vinyl acetate copolymer resins, natural rubber, SBR, NBR, and synthetic rubbers such as silicone rubber. The adhesive may be of a solvent type or a solventless type.

### (Other Optional Layers)

If needed, other optional layers may be provided as needed as long as the effects of the present invention are not impaired.

The thickness of the patterning sheet of the present invention is not particularly limited as long as the total thickness of the infrared-absorbing ink or infrared-reflecting ink layer and other layers before the difference in thickness occurs in some parts is a typical thickness for thermoforming sheets. Due to the reason derived from the production process described below, the thickness is particularly preferably a thickness that is used in vacuum molding.

### (Production Process)

The patterning sheet of the present invention is obtained by irradiating a resin sheet S having a portion A and a portion B having different infrared absorption in a surface processed by a technique (1), (2), or (3) above with an infrared ray while restraining the resin sheet S so that the surface temperature differs between the portion A and the portion B and at least the surface temperature of the portion A is equal to or more than the orientation release stress inflection point temperature T of the resin sheet so as to generate difference in thickness between the portion A and the portion B.

### (Step 1: Restraining)

In step 1, “while restraining” means, as mentioned above, part of or the entire outer periphery of the resin sheet S is fixed in place, i.e., the surface of the sheet S that comes into contact with the injection molding resin is not supported by a substrate or any other component. Examples of the method for restraining the sheet include a method of fixing the sheet in place by clamping some parts of the sheet and a method of fixing the sheet in place by clamping the entire periphery of the resin sheet S using a frame-shaped clamp. The resin sheet is preferably fixed in place by clamping the entire periphery with a frame-shaped clamp since the tension of the resin sheet S can be optimized (made uniform).

The sheet may be fixed in place by clamping with a jig such as a frame-shaped clamp or by preventing plasticization or shrinking of the resin sheet S. In particular, the sheet can be fixed in place by maintaining the sheet temperature of the resin sheets S in portions other than the surface that comes into contact with the injection molding resin, preferably the peripheral portion of the sheet, to a temperature equal to or lower than the glass transition temperature (hereinafter may be referred to as Tg) so as to prevent plasticization.

### (Step 1: Infrared Ray)

While restraining the resin sheet S, an infrared ray is applied so that at least the surface temperature of the portion A is equal to or more than the orientation release stress inflection point temperature T of the resin sheet. As a result, the portion A and the portion B exhibit different surface temperatures and are heated, thereby generating a difference in thickness between the portion A and the portion B.

The infrared ray applied may be any ray in the wavelength ranges of red to near infrared and infrared laser beams. The upper limit of the dose of the infrared radiation is not particularly limited. When an excessively large quantity of heat is applied, the stiffness of the resin sheet S decreases, plasticization proceeds, and molding may not proceed smoothly due to rupture or the like. Thus, the dose is preferably set to adjust the temperature of the highest portion of the resin sheet S used so that the storage elastic modulus (E′) determined by dynamic viscoelasticity measurement in accordance with JIS K7244-1 is 0.5 MPa or more and more preferably 1 MPa.

The infrared radiator may be any device such as an oven, a heater, or the like, that can irradiate the resin sheet S while restraining the resin sheet S. According to the patterning sheet of the present invention, recesses and protrusions can be efficiently developed by infrared irradiation under vacuum molding, as described below. Thus, a known indirect-heating-type thermoforming machine that is used in vacuum molding, vacuum compressed-air molding, or the like is preferably used. The infrared radiator that heats the sheet needs to apply a wavelength that can be absorbed only by the heat-generating substance. Accordingly, a halogen heater, a short wavelength heater, a carbon heater, a mid infrared heater, or the like that has a sharp wavelength peak in the mid infrared to near infrared region is preferably used. The peak of the main wavelength of these infrared radiators is preferably within 1.0 to 3.5 μm and more preferably in the range of 1.5 to 3.0 μm since the thickness can be increased efficiently, the temperature difference between the heat-absorbing substance and other portions is not excessively large, and efficient production is possible.

In many cases, the infrared radiator installed as heating means is controlled based on temperature. Accordingly, in the present invention, the dose of infrared radiation was evaluated not from the dose itself but from the surface temperatures of the portion A and the portion B of the resin sheet S irradiated with the infrared ray.

The minimum dose of the infrared radiation is set so that at least the surface temperature of the portion A of the resin sheet S is equal to or more than the orientation release stress inflection point temperature T of the resin sheet. However, when the temperature of the portion A is excessively high, plasticization of the portion A proceeds and failures such as formation of holes may occur. Accordingly, the maximum dose of infrared irradiation is set so that E′ determined by dynamic viscoelasticity measurement of the portion A is preferably 0.5 MPa or more and more preferably 1.0 MPa or less.

The infrared irradiation may be conducted in an ambient atmosphere but is preferably conducted under vacuum since the recesses and the protrusions can be efficiently developed. Usually, in vacuum molding, heating by infrared irradiation is conducted in an ambient atmosphere. However, the present invention has found that a larger thickness difference can be effectively exhibited at the same temperature when infrared irradiation is conducted in a vacuum state. This is presumably because the wavelength of the infrared ray efficiently reaches the resin sheet S or ink without being affected by the heat conduction in the air. To put it differently, this is presumably because unwanted heat does not readily reach the portion A and the portion B since heated air is rarely present around in the surrounding.

Subsequently, if needed, preform molding may be conducted. Examples of the method for carrying out the preform molding include a hot plate molding method, a vacuum molding method, a ultrahigh pressure molding method, a compressed-air molding method, a compressed-air vacuum molding method, and other existing thermoforming methods. As for the heating methods employed in these methods, an indirect heating method that utilizes heat of radiation from a heater that emits the aforementioned near infrared rays and wavelengths in the mid infrared region is preferably employed since recesses and protrusions can be effectively developed. Among these, an compressed-air vacuum molding method is preferably used.

The mold for preforming is preferably composed of a metal such as stainless steel or silicon since the mold can be readily released. The shape of the mold is not particularly limited and a mold having a flat plate shape, a three-dimensional shape, or the like can be used.

Then unwanted portions are trimmed if needed. The trimming method is not particularly limited. For example, a cutting method using a pair of scissors, a cutter, or the like, a die cutting method, a laser cutting method, a water jet method, a cutting-edge pressing method, or the like can be used.

### (Injection Molded Product)

An injection molded product having recesses and protrusions can be obtained by using the patterning sheet of the present invention.

An injection molded product can be obtained by a method that includes a step of placing the patterning sheet or a preform of the patterning sheet in an injection mold and carrying out injection molding and a step of detaching the resin sheet, in which the thickness difference is generated, after the injection molding.

### (Injection Molding Resin)

The resin used for injection molding is not particularly limited and any known injection molding resin can be used. Examples thereof include ABS resins, ABS-based polymer alloys such as PVC (polyvinyl chloride)/ABS resins, PA (polyamide)/ABS resins, PC (polycarbonate)/ABS resins, and PBT (polybutylene terephthalate)/ABS, AS (acrylonitrile/styrene) resins, AAS (acrylonitrile/acrylic rubber/styrene) resins, AES (Acrylonitrile/ethylene rubber/styrene) resins, MS ((meth)acrylic ester/styrene-based resins, PC-based resins, PMMA (polymethyl methacrylate)-based resins, and PP (polypropylene)-based resins.

An inorganic filler can be added to the injection molding resin to prevent deformation during molding and after molding. The inorganic filler is not particularly limited and the examples thereof include talc, calcium carbonate, clay, diatomaceous earth, mica, magnesium silicate, and silica.

Common additives may be added within the range that does not inhibit the moldability. For example, additives such as a plasticizer, a lightfast additive (UV absorber, stabilizer, etc.), an antioxidant, an ozonization preventing agent, an activator, an antistatic agent, a lubricant, an antifriction agent, a surface adjuster (leveling agent, defoaming agent, blocking preventing agent, or the like), a fungicide, an antibacterial agent, a dispersing agent, a flame retarder, a vulcanization accelerator, a vulcanization accelerator aid, etc., may be blended. These additives may be used alone or in combination.

A coloring agent may be added to the injection molding resin. The amount of the coloring agent added depends on the type of the coloring agent and the desired hue but is preferably 30 parts by mass or less and more preferably 20 parts by mass or less per 100 parts by mass of the injection molding resin.

The coloring agent used is not particularly limited and common inorganic and organic pigments and dyes usually used in coloring thermoplastic resins can be used depending on the desired design. Examples thereof include inorganic pigments such as titanium oxide, titanium yellow, iron oxide, complex oxide-based pigments, ultramarine blue, cobalt blue, chromium oxide, bismuth vanadate, carbon black, zinc oxide, calcium carbonate, barium sulfate, silica, and talc; organic pigments such as azo-based pigments, phthalocyanine-based pigments, quinacridone-based pigments, dioxazine-based pigments, anthraquinone-based pigments, isoindolinone-based pigments, isoindoline-based pigments, perylene-based pigments, perinone-based pigments, quinophthalone-based pigments, thioindigo-based pigments, and diketopyrrolopyrrole-based pigments; and metal complex pigments. As for the dyes, at least one dye selected from the oil-soluble dye group is preferably mainly used.

The conditions for the injection molding are not particularly limited. The injection conditions and the mold temperature may be set according to the type of the injection molding resin. The mold temperature is preferably not more than the orientation release stress inflection point temperature T of the resin sheet S.

For insert molding of a polypropylene resin or an ABS resin, the mold temperature may be adjusted to about water-cooling to 100° C. for both a cavity-side mold and a core-side mold. However, depending on the shape of a transfer-receiving body after insert molding, warping may occur. IN such a case, the mold temperature may be controlled so that the temperature of the cavity-side mold differs from the temperature of the core-side mold. In order to heat a decoration sheet inserted into the mold to a mold temperature before charging the injection molding resin, an injection delay time may be set so that the decoration sheet is retained in the clamped mold for 1 to 100 seconds.

The resin temperature for the injection molding resin is not particularly limited. When a thermoplastic resin such as a polypropylene-based resin or an ABS-based resin is used, the resin temperature is preferably about 180° C. to 250° C. that allows the resin to be injected.

A common insert film may be provided between the pattering sheet of the present invention and the injection molding resin during injection molding. A thermal transfer-type detachable film is preferably used as the insert film.

Injection molded products having recesses and protrusions on surfaces can be continuously produced using the patterning sheet of the present invention by using an injection molding machine for insert molding equipped with a built-in heater that emits wavelengths in near infrared and mid infrared regions capable of irradiating infrared rays, placing a heat-shrinkable resin sheet, which have a portion A and a portion B with different infrared absorbances in the surface of the resin sheet, at the position where the insert film is placed, irradiating the resin sheet with an infrared ray to produce recesses and protrusions, and then conducting injection molding. When an insert film is to be used, the insert film is placed between the patterning sheet of the present invention and the injection molding resin.

### (Detachment)

The patterning sheet is detached from the obtained injection molded product. The detaching method is not particularly limited. For example, an edge at the border may be turned over to peel the sheet. When it is difficult to turn over the border edge, an adhesive tape or the like may be attached to form a detached edge and then the sheet may be peeled. When the patterning sheet and the injection molding resin are composed of resins of the same system, bonding due to thermal fusion occurs and detachment is difficult. When such strong bonding occurs and the detachment becomes difficult, a detachment layer is preferably provided.

### EXAMPLES

The present invention will now be described through Examples. Unless otherwise noted, “parts” and “%” are on a mass basis.

### (Resin Sheet S)

The following sheets were used as the resin sheet S:

Sheet S0: biaxially oriented PET sheet, “SOFTSHINE X1130” produced by TOYOBO Co., Ltd. (thickness: 188 μm)
Sheet S1: biaxially oriented PET sheet, “SOFTSHINE X1130” produced by TOYOBO Co., Ltd. (thickness: 125 μm)
Sheet S2: biaxially oriented PET sheet, “TEFLEX FT3NC3” produced by Teijin DuPont Films Japan Limited (thickness: 50 μm)
Sheet S3: A biaxially oriented polystyrene sheet (thickness: 250 μm), “Polystyrene CR-4500 produced by DIC Corporation” was extruded with an extruder at 210° C., and an unoriented original sheet was formed through a T die. Then the sheet was stretched at a temperature condition of 130° C. into an oriented sheet having a thickness of 250 μm and a thermal shrinkage stress of 0.4 Mpa in the MD direction and 0.5 Mpa in the TD direction.
Sheet S4: Unoriented sheet “A-PET PT700M” produced by Polytech (thickness: 250 μm)

The following films were used as the insert film or an emboss sheet for comparison.

Insert film: thermal transfer-type detachable OPET sheet “T9116-05” produced by Decor Japan (thickness: 52 μm). A transfer layer had a hairline transfer printing layer and a top coating layer and after the film was transferred to an adherend, the top coating layer was cured with UV.
Emboss sheet: embossed decorative sheet, SUNNY CLOTH-05E (recesses and protrusions were formed with a hot roll in advance) produced by Decor Japan (thickness: 140 μm)

### (Method for Measuring Orientation Release Stress Inflection Point Temperature T)

The orientation release stress inflection point temperature T of the resin sheet S was measured as follows. DN-type Stress Tester produced by Nichiri Kogyo Kabushiki Kaisha was used. The scale of a voltage adjustor was set to 6 and the heater temperature was elevated in increments of 5° C. The orientation release stress at each measurement temperature was measured and the orientation release stress inflection point temperature T was read. The results were as follows.

The orientation release stress inflection point temperature T of the sheet S0: 188° C.
The orientation release stress inflection point temperature T of the sheet S1: 188° C.
The orientation release stress inflection point temperature T of the sheet S2: 170° C.
The orientation release stress inflection point temperature T of the sheet S3: 109° C.
The orientation release stress inflection point temperature T of the sheet S5: Not detectable

### (Infrared-Absorbing Ink or Infrared-Reflecting Ink)

The following inks were used as the infrared-absorbing ink or infrared-reflecting ink and the color ink

Ink P1: “Paint marker” black, produced by MITSUBISHI PENCIL CO., LTD., used as the infrared-absorbing ink
Ink P2: “Paint marker” silver, produced by MITSUBISHI PENCIL CO., LTD., used as the infrared-reflecting ink
Ink P3: “Paint marker” blue, produced by MITSUBISHI PENCIL CO., LTD., used as the color ink
Ink G1: gravure printing ink, “NH-NT” black, produced by DIC Graphics Corporation containing carbon black and used as the infrared-absorbing ink
Ink G2: gravure printing ink, “NH-NT” silver, produced by DIC Graphics Corporation containing aluminum paste and used as the infrared-reflecting ink
Ink GH1: gravure printing ink, “XS-756” red, produced by DIC Corporation used as the color ink
Ink GH2: gravure printing ink, “XS-756” blue, produced by DIC Corporation used as the color ink
Ink GH3: gravure printing ink, “XS-756” yellow, produced by DIC Corporation used as the color ink
Ink GH4: gravure printing ink, “XS-756” pearl, produced by DIC Corporation used as the color ink

Regarding the ink G1 and the ink G2, the surface temperature of G2 is higher.

### (Confirmation of Occurrence of Thickness Difference in Step (1))

One of the sheets S1 to S3 was used as the resin sheet S and straight lines having a width of 2 mm were drawn in the machine direction (MD) and the cross direction (CD) with the ink P1 to P3. By using “NGF-0709 molding machine” produced by Fu-se Vacuum Forming, the entire periphery of the sheet was fixed with a clamp under vacuum and the resin sheet S was indirectly heated with a mid-infrared heater produced by Helios from the side opposite to the surface on which the straight lines were drawn.

After confirming with a temperature sensor FT-H30 produced by Keyence Corporation that the surface temperature of the resin sheet S was elevated to the heater setting temperature, the resin sheet S was cooled to room temperature and the clamp was removed to obtain a sample.

The surface temperatures of the portion A on which the ink was applied and the portion B on which no ink was applied were measured with Thermo Tracer TH9100 produced by NEC/Avio. That is, the difference in temperature/° C. between the portion A and the portion B at the time when the portion A reached the orientation release stress inflection point temperature T of the resin sheet S used and the temperatures of the portion A and the portion B at the time when the surface temperature of the resin sheet S was elevated to the heater setting temperature (this temperature is usually the temperature at which it is judged that thermoforming is possible) were measured.

The thickness of the portion A and the portion B was measured with K351C produced by ANRITSU and the height difference was measured with a surface roughness system, SURFCOM ver 1.71 produced by TOKYO SEIMITSU CO., LTD., so as to measure the maximum thickness difference between the portion A and the portion B.

Described below are Reference Examples in which the combinations of the sheets S1 to S3 and the inks P1 to P2 were changed as shown in Table 1. The results are shown in Table 1-1, Table 1-2, and Table 2.

TABLE 1-1

| | | Reference | Reference | Reference | Reference |
|---|---|---|---|---|---|
| | | Example 1 | Example 2 | Example 3 | Example 4 |
| Type of resin sheet S | | Sheet S0 | Sheet S0 | Sheet S1 | Sheet S0 |
| Orientation release stress | | 188° C. | 188° C. | 188° C. | 188° C. |
| inflection point temperature T | | | | | |
| of resin sheet S | | | | | |
| Ink | | Ink P1 | Ink P1 | Ink P2 | Ink P1 |
| Factor of expansion % | | 100 | 100 | 100 | 100 |
| Heater setting temperature/° C. | | 180 | 190 | 180 | 195 |
| Temperature difference | | 13 (temperature | 13 (temperature | 30 (temperature | 13 (temperature |
| between portions A and B at | | difference when | difference when | difference when | difference when |
| the time when the portion A | | the portion A | the portion A | the portion A | the portion A |
| reaches the orientation | | reached 188° C.) | reached 188° C.) | reached 188° C.) | reached 188° C.) |
| release stress inflection point | | | | | |
| temperature T of the resin | | | | | |
| sheet S used/° C. | | | | | |
| Resin sheet | Portion A | 196 | 206 | 227 | 213.4 |
| S surface | Portion B | 183 | 198 | 180 | 211.5 |
| temperature/° C. | Temperature | 13 | 8 | 47 | 1.9 |
| | difference | | | | |
| Resin sheet | Portion A | 152 | 84 | 67 | 70 |
| S thickness/μm | Portion B | 195 | 209 | 130 | 231 |
| | Thickness | 43 | 125 | 63 | 161 |
| | difference | | | | |
| E′ MPa | Portion A | 28 | 20 | 4.9 | 17 |
| | Portion B | 39 | 25 | 42 | 18 |

TABLE 2

| | | Reference | Reference |
|---|---|---|---|
| Table 1-2 | | Example 5 | Example 6 |
| Type of resin sheet S | | Sheet S2 | Sheet S3 |
| Orientation release stress | | 170° C. | 109° C. |
| inflection point temperature | | | |
| T of resin sheet S | | | |
| Ink | | Ink P1 | Ink P2 |
| Factor of expansion % | | 100 | 100 |
| Heater setting temperature/° C. | | 170 | 90 |
| Temperature difference between | | 15 (temperature | 18 (temperature |
| portions A and B at the time when | | difference when | difference when |
| the portion A reaches the | | the portion A | the portion A |
| orientation release stress inflection | | reached 188° C.) | reached 188° C.) |
| point temperature T of the resin | | | |
| sheet S used/° C. | | | |
| Resin sheet | Portion A | 184 | 133 |
| S surface | Portion B | 174 | 112 |
| temperature/ | Temperature | 7 | 21 |
| ° C. | difference | | |
| Resin sheet | Portion A | 40 | 241 |
| S thickness/ | Portion B | 25 | 149 |
| μm | Thickness difference | 15 | 92 |
| E′ MPa | Portion A | 6.3 | 1.1 |
| | Portion B | 10 | 28 |

TABLE 2

| | | Reference | Reference | Reference |
|---|---|---|---|---|
| | | Comparative | Comparative | Comparative |
| | | Example 1 | Example 2 | Example 3 |
| Type of resin sheet S | | Sheet S0 | Sheet S0 | Sheet S4 |
| Orientation release stress | | 188° C. | 188° C. | None |
| inflection point temperature T | | | | |
| of resin sheet S | | | | |
| Ink | | Ink P1 | Ink P3 | Ink P2 |
| Factor of expansion % | | 100 | 100 | 100 |
| Heater setting temperature/° C. | | 175 | 190 | 100 |
| Temperature difference | | 13 (temperature | 5 (temperature | — |
| between portions A and B at | | difference when | difference when | |
| the time when the portion A | | the portion A | the portion A | |
| reaches the orientation | | reached 188° C.) | reached 188° C.) | |
| release stress inflection point | | | | |
| temperature T of the resin | | | | |
| sheet S used/° C. | | | | |
| Resin sheet | Portion A | 185 | 203 | 121 |
| S surface | Portion B | 175 | 198 | 100 |
| temperature/° C. | Temperature | 10 | 5 | 21 |
| | difference | | | |
| Resin sheet | Portion A | 201 | 212 | 243 |
| S thickness/μm | Portion B | 196 | 215 | 239 |
| | Thickness | 5 | 3 | 4 |
| | difference | | | |
| E′ MPa | Portion A | 48 | 22 | 6.5 |
| | Portion B | 48 | 25 | 8.0 |

The results show that satisfactory recesses and protrusions could be developed in Reference Examples 1 to 6.

Reference Comparative Example 1 is an example in which the temperature of the portion A was lower than the orientation release stress inflection point temperature of the sheet. In this example, the recesses and protrusions could not be developed.

Reference Comparative Example 2 is an example in which a color ink was used. Although the portion A was heated to higher than the orientation release stress inflection point temperature, the recesses and protrusions could not be developed.

Reference Comparative Example 3 is an example in which the sheet S4 having no heat shrinkability (having no orientation release stress inflection point temperature) was used. The setting temperature in the heater was higher than the thermosoftening point of S4 and was the temperature at which molding can be conducted without any failure. However, the recesses and protrusions could not be developed.

### (Injection Molding Resin)

Injection molding resin P1: KRALASTIC GA-501 produced by Nippon A&L Inc., injection molding resin temperature: 240° C.

Injection molding resin P2: Multilon T-3714 produced by Teijin Chemicals Ltd., injection molding resin temperature: 270° C.

Injection molding resin P3: DIC Styrene XC520 produced by DIC Corporation, injection molding resin temperature: 220° C.

### (Design Printing Method)

A design having a thickness of 3 μm was printed on the resin sheet S with the ink G1 or G2 by using a gravure four-color printing machine.

### Example 1

### Method for Making Patterning Sheet (1)

The sheet S1 was used as the resin sheet S. A particular design was gravure-printed with the ink G1 (refer to FIG. 8). After the periphery of the resin sheet S was clamped, the upper and lower boxes of “NGF-0709 molding machine” produced by Fu-se Vacuum Forming were closed and the interior of the box was substantially completely vacuumed. Then the resin sheet S was indirectly heated from the upper surface by using a mid-infrared heater produced by Helios. After the surface temperature of the resin sheet S1 was elevated to a setting temperature for starting molding, the resin sheet S1 was cooled to room temperature and removed from the clamp. As a result, a patterning sheet (1) having recesses and protrusions formed on both the printed surface and the non-printed surface was obtained (refer to FIG. 9).

### Example 2

### Method for Making Preformed Patterning Sheet (2)

The sheet S1 was used as the resin sheet S. A particular design was gravure-printed with the ink G2 (refer to FIG. 8). After the periphery of the resin sheet S was clamped, the upper and lower boxes of “NGF-0709 molding machine” produced by Fu-se Vacuum Forming were closed and the interior of the box was substantially completely vacuumed. Then the resin sheet S was indirectly heated from the upper surface by using a mid-infrared heater produced by Helios. A table on which a flat and smooth stainless-steel plate was placed was lifted and compressed air of 0.2 MPa was blown into the upper box to press the stainless-steel plate onto the non-printed surface of the resin sheet S. As a result, a preformed patterning sheet (2) having recesses and protrusions formed on only the printed surface was obtained (refer to FIG. 10).

### Example 3

### Method for Making Preformed Patterning Sheet (3)

The sheet S3 was used as the resin sheet S. A particular design was gravure-printed with the ink G1 (refer to FIG. 8).

A preformed patterning sheet (3) having recesses and protrusions only on the printed surface was obtained as in Example 2 (refer to FIG. 10).

### Example 4

### Method for Making Preformed Patterning Sheet (4)

The sheet S2 was used as the resin sheet S. A particular design was gravure-printed with the ink G1 (refer to FIG. 8).

A preformed patterning sheet (4) having recesses and protrusions only on the printed surface was obtained as in Example 2 (refer to FIG. 10).

### Reference Examples 1 to 4

### Method for Making Injection Molded Product

Each of the patterning sheets (1) to (4) obtained in Examples 1 to 4 above was brought into close contact with a female mold of the injection mold so that a surface opposite to the ink layer was in contact with the female mold and heated at a mold temperature of 50° C. Then one of the injection molding resins P1 to P3 was heated to a predetermined injection molding resin temperature and injected into the mold to conduct integral molding. The mold was removed, the patterning sheet was detached, and injection molded products (1) to (4) were obtained as a result. The injection molding machine used was EC75N-1.5Y produced by Toshiba Machine Co., Ltd. The injection mold used was a tray-shaped mold A 99.5 (L)×99.5 (W)×12.5 (H) mm in size, with a corner R of 10 mm, R of upstanding portions=5R, and a draft of 18.5°.

The thickness difference reproducibility and the scratch resistance of the resulting injection molded products of Reference Examples 1 to 4 were evaluated as follows.

### (Evaluation of Thickness Difference Reproducibility of Injection Molded Product)

A: The pattern transfer ratio determined by thickness difference in decorated injection molded product/maximum thickness difference of film before injection molding×100 was 90% or more.
B: The pattern transfer ratio determined by thickness difference in decorated injection molded product/maximum thickness difference of film before injection molding×100 was less than 90%.
F: The pattern transfer ratio determined by thickness difference in decorated injection molded product/maximum thickness difference of film before injection molding×100 was less than 30%.
The maximum thickness difference in film before injection molding was the thickness difference value of the resin sheet S or a patterning sheet with the largest thickness difference.

### (Evaluation of Scratch Resistance Test)

Using a rubbing tester (produced by Taihei Rikagaku Kogyo Kabushiki Kaisha), a piece of absorbent cotton thoroughly impregnated with a 5% cleanser solution and placed on the injection molded product surface was pressed with a tester terminal and moved 30 times in a reciprocating manner under a load of 1 kg. The injection molded product was then washed with water and immediately towel-dried. The coated surface was observed. Evaluation was done by comparing with a comparative plate composed of the same resin prepared without a patterning sheet. The standard used was as follows.

A: No difference from the comparative plate was observed.
B: Gloss was slightly low compared to the comparative plate.
C: Gloss was significantly low.

The results are shown in Table 4.

TABLE 3

| | Example 1 | Example 2 | Example 3 | Example 4 |
|---|---|---|---|---|
| Type of resin sheet S | Sheet S1 | Sheet S1 | Sheet S3 | Sheet S2 |
| Configuration of | One plate | One plate | One plate | One plate |
| printing plate | | | | |
| Ink | G1 | G2 | G1 | G1 |
| Factor of expansion % | 100 | 100 | 100 | 100 |
| Setting temperature for | 185 | 185 | 100 | 170 |
| starting molding/° C. | | | | |
| Temperature difference | 12 (temperature | 10 (temperature | 9 (temperature | 15 (temperature |
| between portions A and B at | difference when | difference when | difference when | difference when |
| the time when the portion A | the portion A | the portion A | the portion A | the portion A |
| reaches the orientation | reached 188° C.) | reached 188° C.) | reached 109° C.) | reached 170° C.) |
| release stress inflection point | | | | |
| temperature T of the resin | | | | |
| sheet S used/° C. | | | | |

TABLE 4
Evaluation of injection molded product

| | | Reference | Reference | Reference | Reference |
|---|---|---|---|---|---|
| | | Example 1 | Example 2 | Example 3 | Example 4 |
| Type of injection molding resin P | | P1 | P3 | P2 | P1 |
| Resin sheet | Portion A | 213 | 206 | 123 | 184 |
| S surface | Portion B | 200 | 197 | 111 | 174 |
| temperature/° C. | Temperature | 13 | 9 | 12 | 7 |
| | difference | | | | |
| Patterning sheet | Portion A | 81 | 75 | 210 | 40 |
| thickness/μm | Portion B | 135 | 128 | 302 | 25 |
| | Thickness | 54 | 53 | 92 | 15 |
| | difference | | | | |
| Thickness difference | Depth | 53 | 53 | 90 | 13 |
| in injection molded | difference | | | | |
| product | Reproducibility | A | A | A | A |
| Evaluation of scratch | — | A | A | A | A |
| resistance test | | | | | |

### Reference Example 5

### Method for Making Decorated Injection Molded Product Using Insert Film

The patterning sheet (2) obtained in Example 2 and an insert film, “T9116-05” produced by Decor Japan were placed in an injection mold in a superposed manner so that the surface of the patterning sheet (2) opposite to the ink layer is in close contact with a female mold and that the ink layer of the patterning sheet (2) is in contact with the surface of the insert film opposite to the ink layer of the insert film.

After heating at a mold temperature of 50° C., the injection molding resin P2 was heated to a particular injection molding resin temperature and injected into the mold to conduct integral molding. After the mold was removed, the patterning sheet and the releasing film of the insert film were detached to obtain an injection molded product (5) on which a hairline printed layer and the top coating layer were transfer-printed. Then the top coating layer transferred from the insert film was cured by irradiation with UV light at a dose of 1000 mJ/cm² and a peak intensity of 200 mW/cm² by using a UV irradiator produced by GS Yuasa Corporation equipped with a high-pressure mercury lamp (main wavelengths: 254 nm, 313 nm, 365 nm, 405 nm, 436 nm, 546 nm, and 577 nm) produced by GS Yuasa Corporation. The results are shown in Table 5.

TABLE 5
Evaluation of injection molded product

| | | Reference |
|---|---|---|
| | | Example 5 |
| Type of injection molding resin P | | P2 |
| Resin sheet | Portion A | 206 |
| S surface | Portion B | 197 |
| temperature/° C. | Temperature | 9 |
| | difference | |
| Patterning sheet | Portion A | 75 |
| thickness/μm | Portion B | 128 |
| | Thickness | 53 |
| | difference | |
| Height difference | Depth | 51 |
| in injection molded | difference | |
| product | Reproducibility | A |
| Evaluation of scratch | A | A |
| resistance test | | |

### Example 6

### Method for Making Preformed Patterning Sheet (6)

The sheet S2 was used as the resin sheet S. A particular design was gravure-printed with the inks G1, GH1, GH2, and GH4 on a surface protection layer (hereinafter referred to as TP) coating the surface of the sheet S2 (refer to FIG. 11).

A preformed patterning sheet (6) in which recesses and protrusions were formed only on a non-printed surface was obtained as in Example 2 except that the printed surface of the sheet S2 was pressed against the stainless steel plate (refer to FIG. 12).

### Reference Example 6

### Method for Making Injection Molded Product (6)

An injection molded product (6) was obtained as in Reference Examples 1 to 4 (refer to FIGS. 13 to 16).

The ink G1 and the ink GH1 were transferred to the injection molded product (6). The results are shown in Table 7.

### (Surface Protection Layer)

The surface protection layer was formed by applying a 1:1 mixture of a hydroxyl-containing copolymer and a polyisocyanate compound to a thickness of 10 μm.

### (Hydroxyl-Containing Copolymer)

A mixed solution of 850 parts of butyl acetate and 1 part of PERBUTYL Z (trade name, t-butyl peroxybenzoate produced by NOF Corporation) was heated to 110° C., and a mixed solution of 660 parts of methyl methacrylate, 150 parts of t-butyl methacrylate, and 190 parts of 2-hydroxyethyl methacrylate and a mixed solution of 200 parts of isobutyl acetate, 9 parts of PERBUTYL O (trade name, t-butylperoxy-2-ethylhexanoate produced by NOF Corporation), and 2 parts of PERBUTYL Z (trade name, t-butylperoxybenzoate produced by NOF Corporation) were added dropwise thereto for about 5 hours in a nitrogen atmosphere, followed by stirring for 15 hours. As a result, a hydroxyl-containing copolymer having a solid content of 60% was obtained. The weight-average molecular weight of the resulting resin was 100,000, the hydroxyl value of the solid matter was 79 KOHmg/g, and the glass transition temperature Tg was 95° C. The weight-average molecular weight is a polystyrene equivalent value determined by GPC, the hydroxyl value is a calculated value of the amount of the KOH needed for neutralization based on the monomer feed composition, and the polymer Tg is a value measured by DSC.

### (Polyisocyanate Compound)

An isocyanurate-ring-containing polyisocyanate, “BURNOCK DN-981” (trade name, produced by DIC Corporation, number average molecular weight: about 1000, involatile content: 75% (solvent: ethyl acetate), number of functional groups: 3, NCO concentration: 13 to 14%) was used as the polyisocyanate compound.

### Example 7

### Method for Making Preformed Patterning Sheet (7)

The sheet S1 was used as the resin sheet S and a particular design was gravure-printed with the ink G1 (refer to FIG. 8).

After the periphery of the resin sheet S was clamped, the upper and lower boxes of “NGF-0709 molding machine” produced by Fu-se Vacuum Forming were closed and the interior of the box was substantially completely vacuumed. Then the resin sheet S was indirectly heated from the upper surface by using a mid-infrared heater produced by Helios. After the surface temperature of the resin sheet S1 was elevated to a setting temperature for starting molding, a table carrying a tray-shaped mold A 99.5 (L)×99.5 (W)×12.5 (H) mm in size, with a corner R of 10 mm, R of upstanding portions=5R, and a draft of 18.5° was lifted and compressed air of 0.2 MPa was blown into the upper box. As a result, a patterning sheet (7) preformed with the mold A and having protrusions and recesses formed on only the printed surface was obtained.

### Reference Example 7

### Method for Making Injection Molded Product (7)

The patterning sheet (7) was brought into close contact with a female mold of an injection mold having the same shape as the mold A, followed by heating at a mold temperature of 50° C. Then the injection molding resin P3 was heated to a particular injection molding resin temperature and injected into the mold to conduct integral molding. After the mold was removed, the patterning sheet (7) was detached. As a result, an injection molded product (7) was obtained. The results are shown in Table 7.

TABLE 6

| | Example 6 | Example 7 |
|---|---|---|
| Type of resin sheet S | Sheet S2 | Sheet S1 |
| Configuration of | Four plates | One plate |
| printing plate | | |
| Ink | G1, GH1, GH2, | G2 |
| | and GH4 | |
| Factor of expansion % | 100 | 120 |
| Setting temperature for | 175 | 185 |
| starting molding/° C. | | |
| Temperature difference | 18 (temperature | 10 (temperature |
| between portions A and B at | difference when | difference when |
| the time when the portion A | the portion A | the portion A |
| reaches the orientation | reached 170° C.) | reached 188° C.) |
| release stress inflection point | | |
| temperature T of the resin | | |
| sheet S used/° C. | | |

TABLE 7
Evaluation of injection molded product

| | | Reference | Reference |
|---|---|---|---|
| | | Example 6 | Example 7 |
| Type of injection molding resin P | | P2 | P3 |
| Resin sheet | Portion A | 189 | 206 |
| S surface | Portion B | 178 | 197 |
| temperature/° C. | Temperature | 11 | 9 |
| | difference | | |
| Patterning sheet | Portion A | 37 | 59 |
| thickness/μm | Portion B | 61 | 103 |
| | Thickness | 24 | 44 |
| | difference | | |
| Thickness difference | Depth | 22 | 39 |
| in injection molded | difference | | |
| product | Reproducibility | A | A |
| Evaluation of scratch | A | A | A |
| resistance test | | | |

### Comparative Example 1

### Example in which Infrared Rays were Not Used as the Heat Source and a Patterning Sheet Having No Recesses or Protrusions was Used

A patterning sheet (H1) was obtained as in Example 1 except that instead of using the mid infrared heater produced by Helios in Example 1, a gear oven GPHH-100 produced by Tabai MFG. Co., Ltd., (heat source is hot air) heated to and kept at a particular temperature was used and the sheet was placed in the oven for 5 minutes.

### Comparative Reference Example 1

### Method for Making Injection Molded Product (H1)

An injection molded product (H1) was obtained as in Reference Examples 1 to 4 except that the patterning sheet (H1) was used. The results are shown in Table 8. As a result, no thickness difference was developed and a decorated molded body having recesses and protrusions was not obtained.

TABLE 8

| | | Comparative |
|---|---|---|
| | | Example 1 |
| Type of resin sheet S | | Sheet S1 |
| Configuration of printing plate | | One plate |
| Ink | | G1 |
| Factor of expansion % | | 100 |
| Setting temperature for starting molding/° C. | | 185 (hot air) |
| Temperature difference between portions A | | 10 (temperature |
| and B at the time when the portion A reaches | | difference when |
| the orientation release stress inflection point | | the portion A |
| temperature T of the resin sheet S used/° C. | | reached 188° C.) |
| | | Comparative |
| Evaluation of injection molded product | | Reference Example 1 |
| Type of injection molding resin P | | P3 |
| Resin sheet | Portion A | 198 |
| S surface | Portion B | 198 |
| temperature/° C. | Temperature | 0 |
| | difference | |
| Patterning sheet | Portion A | 131 |
| thickness/μm | Portion B | 133 |
| | Thickness | 2 |
| | difference | |
| Thickness difference | Depth | 0 |
| in injection molded | difference | |
| product | Reproducibility | A |
| Evaluation of sratch | — | A |
| resistance test | | |

### Comparative Reference Example 2

### Method for Making Injection Molded Product (H2)

An injection molded product (H2) was made as in Example 6 except that an embossed decorative sheet, “SUNNY CLOTH-05E (thickness: 140 μm)” produced by Decor Japan was used as the sheet. Since “SUNNY CLOTH-05E” has recesses and protrusions formed in advance with a hot roll, the depth of the recesses of the sheet S6 before preliminary molding, the depth of the recesses of the sheet S6 after preliminary molding, and the thickness difference in the injection molded product (H2) are indicated. The reproducibility was evaluated on the basis of the thickness difference of “SUNNY CLOTH-05E” having the largest thickness difference. As a result, the recesses and protrusions were reduced during the production of the preform and thus the thickness difference reproducibility of the injection molded product (H2) was F. The results are shown in Table 9.

TABLE 9

| | | Comparative |
|---|---|---|
| | | Example 2 |
| Type of resin sheet S | | SUNNY CLOTH-05E |
| Factor of expansion % | | 120 |
| Setting temperature for starting molding/° C. | | 113 |
| | | Comparative |
| Evaluation of injection molded product | | Reference Example 2 |
| Type of injection molding resin P | | P3 |
| Resin sheet | Portion A | 123 |
| S surface | Portion B | — |
| temperature/° C. | Temperature | — |
| | difference | |
| Resin sheet S | Minimum | 65 |
| thickness/μm | | |
| | Maximum | 145 |
| | Thickness | 80 |
| | difference | |
| Patterning sheet | Minimum | 87 |
| thickness/μm | Maximum | 120 |
| | Thickness | 33 |
| | difference | |
| Thickness difference | Depth | 13 |
| in injection molded | difference | |
| product | Reproducibility | F |
| Evaluation of scratch | A | A |
| resistance test | | |

### BRIEF DESCRIPTION OF DRAWINGS

FIG. 1 is a diagram showing a specific embodiment in which an infrared ray is applied by using a infrared heater to a heat-shrinkable resin sheet having a design printed with an infrared-absorbing ink.

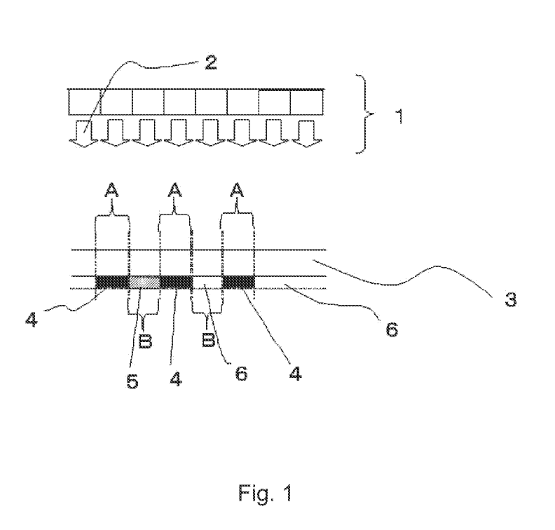

FIG. 2 is a diagram showing a state of the resin sheet after the resin sheet is irradiated with an infrared ray while being restrained.

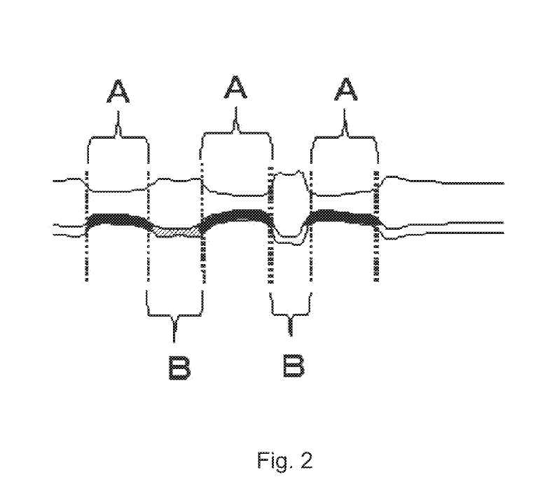

FIG. 3 shows an example of a design printed layer used in the present invention. A dark portion indicates the printed layer. (Stripe)

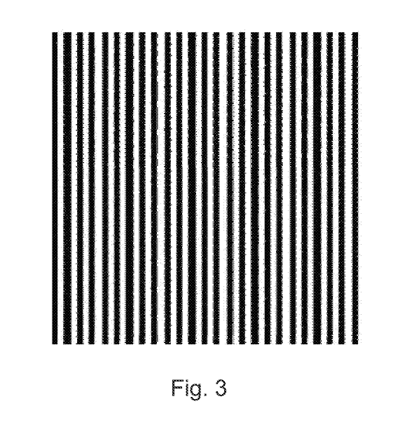

FIG. 4 shows an example of a design printed layer used in the present invention. A dark portion indicates the printed layer. (Dot)

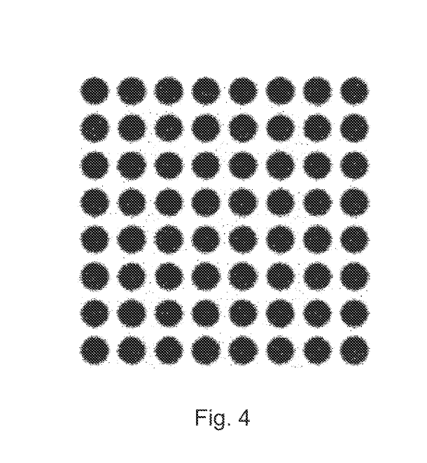

FIG. 5 shows an example of a design printed layer used in the present invention. A dark portion indicates the printed layer. (Geometric pattern)

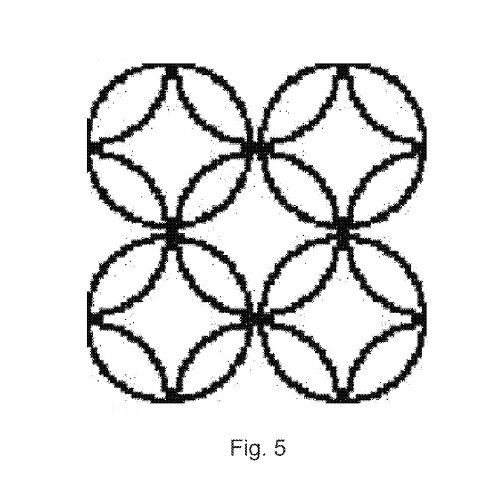

FIG. 6 shows an example of a design printed layer used in the present invention. A dark portion indicates the printed layer. (Wood grain)

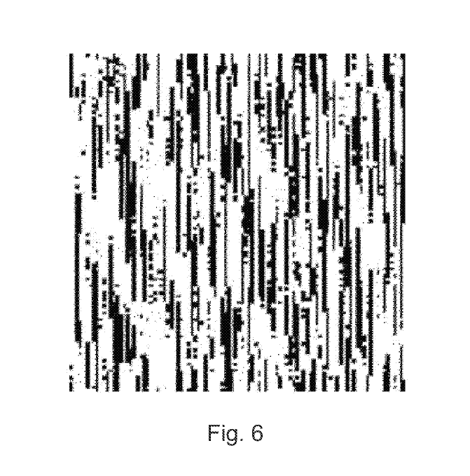

FIG. 7 is a graph showing the temperature and the orientation release stress measured from a biaxially oriented PET sheet “Soft Shine X1130 (thickness: 125 μm) (sheet S1 in Examples) produced by TOYOBO Co., Ltd., in accordance with ASTM D-1504.

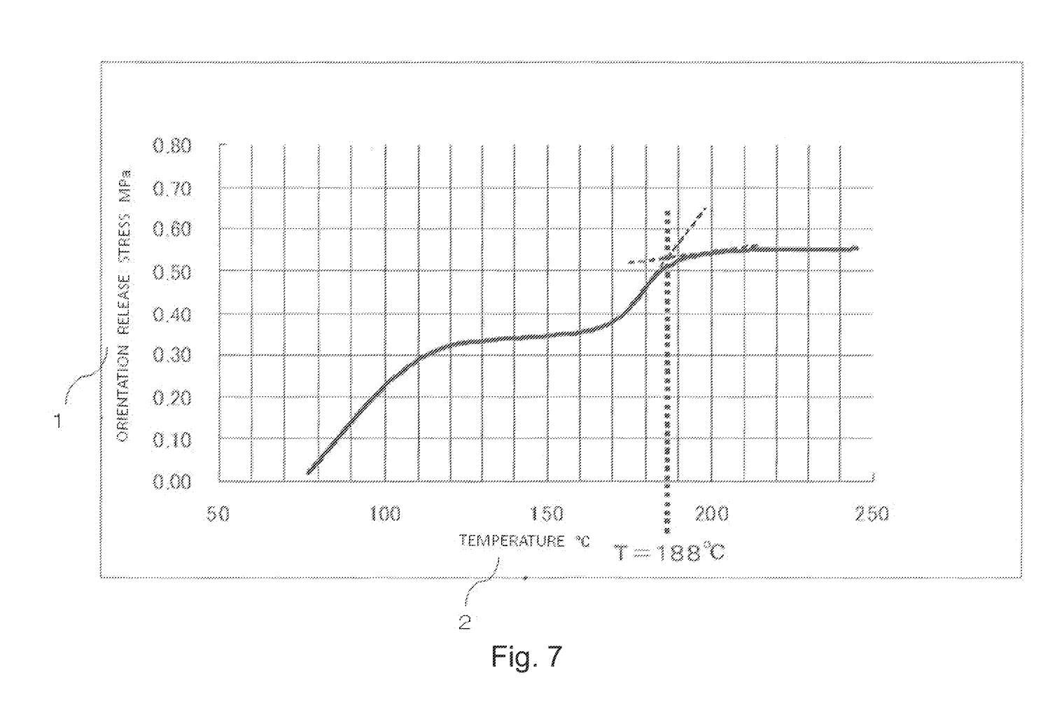

FIG. 8 includes diagrams of a printed resin sheet S of patterning sheets (1) to (4) and (7) in Examples. The upper diagram is a plan view and the lower diagram is a cross-sectional view in the black frame in the plan view.

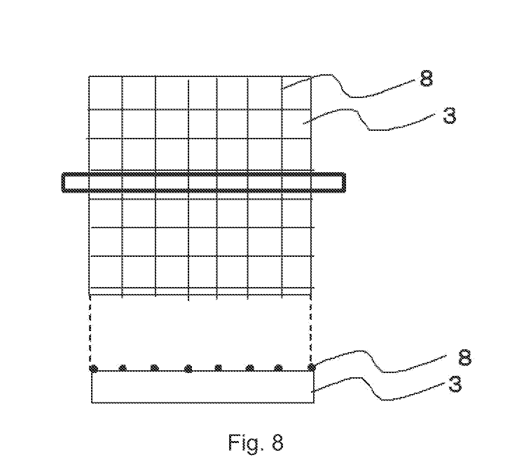

FIG. 9 is a schematic cross-sectional view of the patterning sheet (1) of Examples.

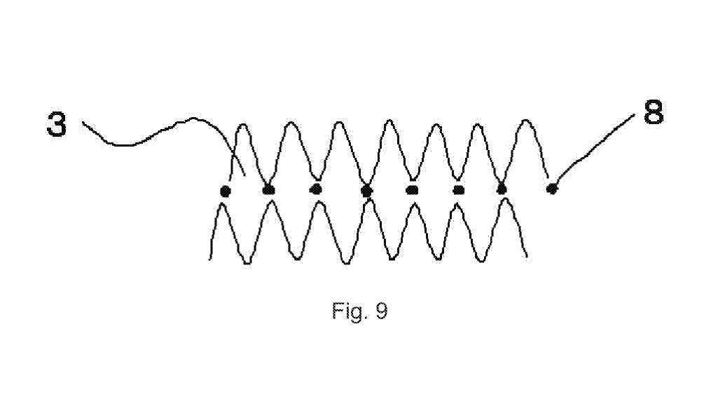

FIG. 10 is a schematic cross-sectional view of the patterning sheets (2) to (4) and (7) in Examples.

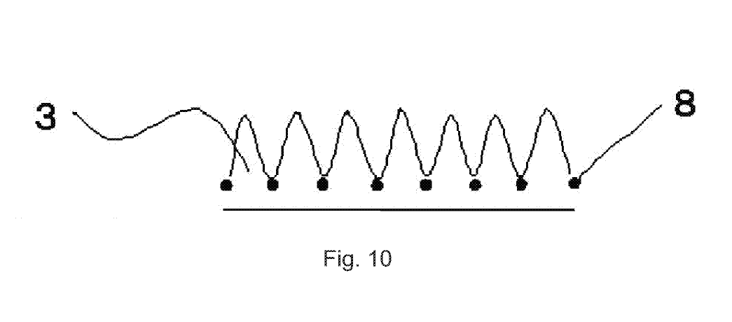

FIG. 11 includes diagrams of a printed resin sheet S of a patterning sheet (6) in Examples. The upper diagram is a plan view and the lower diagram is a cross-sectional view in the black frame in the plan view.

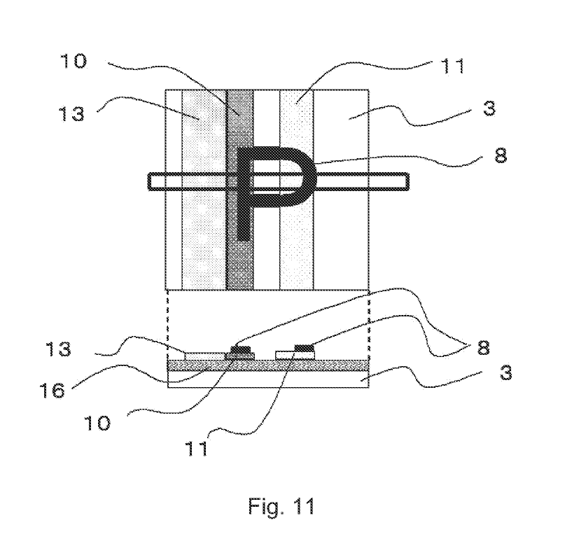

FIG. 12 is a schematic cross-sectional view of the patterning sheet (6) of Examples.

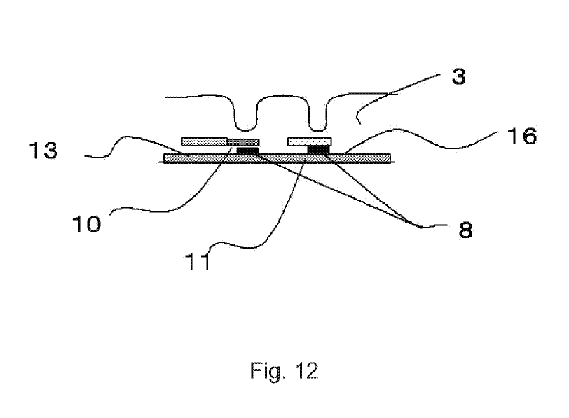

FIG. 13 is a schematic diagram showing a method for making an injection molded product of Reference Example 6.

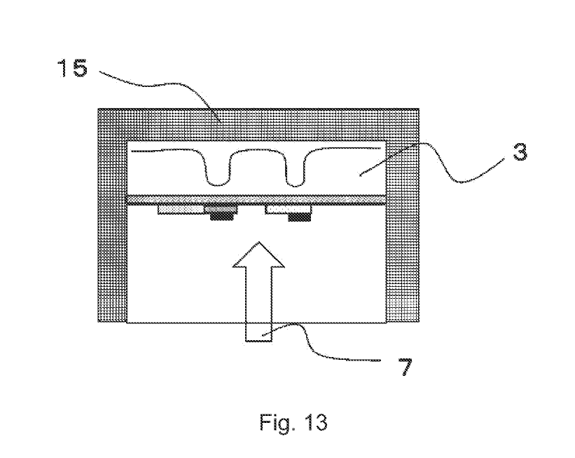

FIG. 14 is a schematic diagram showing a method for making an injection molded product of Reference Example 6.

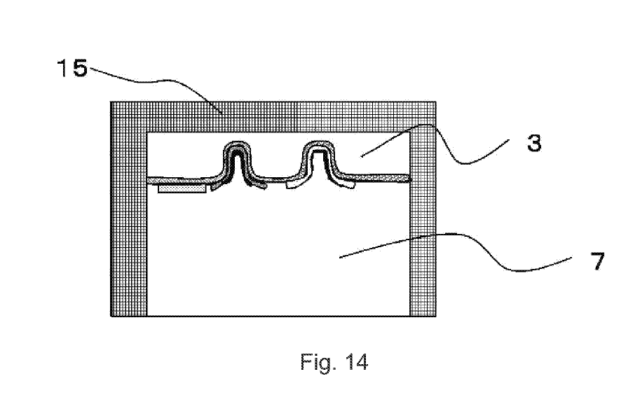

FIG. 15 is a schematic diagram showing a method for making an injection molded product of Reference Example 6.

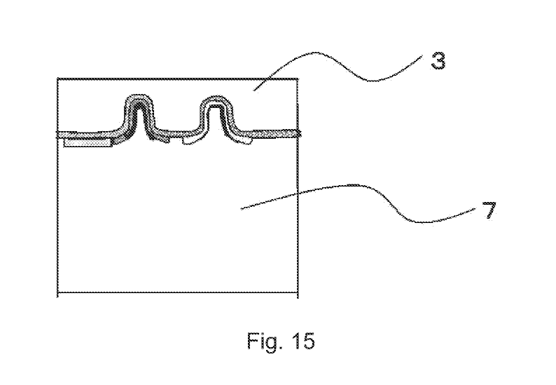

FIG. 16 is a schematic diagram showing a method for making an injection molded product of Reference Example 6.

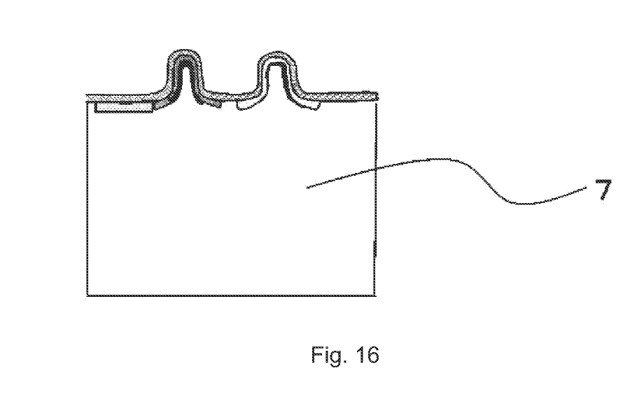

### REFERENCE SIGNS LIST

1: infrared heater
2: infrared ray
3: heat-shrinkable resin film
4: infrared-absorbing ink printed portion having a high concentration
5: infrared-absorbing ink printed portion having a low concentration
6: color ink printed portion (not absorbing infrared rays
7: injection molding resin
8: ink G1
9: ink G2
10: ink GH1
11: ink GH2
12: ink GH3
13: ink GH4
14: ink G4
15: injection mold
16: surface protection layer

1-9. (canceled)

10. A method for making a patterning sheet that can form recesses and protrusions on a surface of an injection molded product by conducting injection molding while inserting the patterning sheet in an injection mold and then detaching the patterning sheet, the patterning sheet having a thickness difference in some part and being formed by irradiating an infrared ray on a heat-shrinkable resin sheet having a portion A and a portion B that are formed in a surface and have infrared-absorbing properties different from each other, the method comprising:
irradiating a heat-shrinkable resin sheet having a portion A and a portion B, which have infrared-absorbing properties different from each other, in a surface with an infrared ray while restraining the resin sheet so that surface temperatures of the portion A and the portion B are different from each other and at least the surface temperature of the portion A is equal to or more than an orientation release stress inflection point temperature T of the resin sheet to generate a thickness difference between the portion A and the portion B.

11. The method for making the patterning sheet according to claim 10, wherein the heat-shrinkable resin sheet has a design formed with an infrared-absorbing ink or an infrared-reflecting ink and has the portion A on which the design is formed with the infrared-absorbing ink or the infrared-reflecting ink and the portion B on which no design is formed.

12. The method for making the patterning sheet according to claim 10, wherein the heat-shrinkable resin sheet has a design formed with an infrared-absorbing ink or an infrared-reflecting ink, and has the portion A in which an ink concentration is high and the portion B in which an ink concentration is low.

13. The method for making the patterning sheet according to claim 10, wherein the heat-shrinkable resin sheet has a design formed with a plurality of types of infrared-absorbing inks or infrared-reflecting inks having infrared absorbance or reflectance different from one another, and has the portion A in which the design is formed with an ink having a high infrared absorbance or reflectance and the portion B in which the design is formed with an ink having a low infrared absorbance or reflectance.

14. The method for making the patterning sheet according to claim 10, wherein the heat-shrinkable resin sheet is composed of biaxially oriented polyethylene terephthalate.

15. A patterning sheet that can form recesses and protrusions on a surface of an injection molded product by conducting injection molding while inserting the patterning sheet in an injection mold and then detaching the patterning sheet,
wherein a heat-shrinkable resin sheet having a portion A and a portion B in a surface, the portion A and the portion B having infrared-absorbing properties different from each other, is irradiated with an infrared ray so that at least a surface temperature of the portion A is equal to or more than an orientation release stress inflection point temperature T of the resin sheet so as to generate a thickness difference in some part between the portion A and the portion B.

16. The patterning sheet according to claim 15, wherein the patterning sheet has a thickness difference in some part and is formed by irradiating an infrared ray on a heat-shrinkable resin sheet on which an infrared-absorbing ink or an infrared-reflecting ink is printed.

17. The patterning sheet according to claim 15, wherein the heat-shrinkable resin sheet is composed of biaxially oriented polyethylene terephthalate.

18. The patterning sheet according to claim 15, wherein the heat-shrinkable resin sheet has a design layer which can be transferred.
